(19) United States
(12) Patent Application Publication
(10) Pub. No.: US 2026/0220054 A1
(43) Pub. Date: Jul. 30, 2026

(54) INFORMATION TRANSMISSION APPARATUS, SYSTEM, AND METHOD

(71) Applicant: SUZHOU METABRAIN INTELLIGENT TECHNOLOGY CO., LTD., Suzhou, Jiangsu (CN)

(72) Inventors: Dongdong JI, Suzhou, Jiangsu (CN); Guangle ZHANG, Suzhou, Jiangsu (CN); Jinyou WANG, Suzhou, Jiangsu (CN); Zhipeng ZHANG, Suzhou, Jiangsu (CN)

(21) Appl. No.: 19/142,607

(22) PCT Filed: Feb. 28, 2024
(86) PCT No.: PCT/CN2024/078894

§ 371 Date: Jun. 23, 2025

(30) Foreign Application Priority Data
Apr. 13, 2023 (CN) 202310396818.9

(51) Int. Cl. G06F 13/12

(52) U.S. Cl. CPC G06F 13/126; G06F 2213/0016; G06F 2213/0026

(57) ABSTRACT

An information transmission apparatus, an information transmission system, and an information transmission method are provided by embodiments of the present application. The information transmission apparatus includes: a plurality of inter-integrated circuit (I2C) controller, each of the I2C controllers being configured to connect to an I2C interface of an I2C device. The information transmission apparatus is configured to receive a control instruction sent by an upper-layer controller and perform parallel access to I2C devices according to the control instruction. That is, the information transmission apparatus and the upper-layer controller are connected. The I2C controllers with the same number as the I2C devices are disposed in the information transmission apparatus, thereby parallel access to the I2C devices by the information transmission apparatus is realized.

### CROSS-REFERENCE TO RELATED APPLICATION

This application claims the priority of the Chinese Patent application filed on Apr. 13, 2023 before the China National Intellectual Property Administration with the application number of 202310396818.9, and the title of “INFORMATION TRANSMISSION APPARATUS, SYSTEM, AND METHOD”, which is incorporated herein in its entirety by reference.

### FIELD

The present application relates to the technical field of communication and, more particularly, to an information transmission apparatus, system, and method.

### BACKGROUND

An optical module is an important part of a switch system, by using the optical module, an external interface for the switch system is provided, so as to realize data communication among the local machine and different devices. The optical module provides management and state registers, and an upper-layer controller may acquire the state and control of the optical module from the registers of the optical module. Therefore, the management and control part of each optical module is equivalent to an inter-integrated circuit (I2C) device. The I2C device refers to a device that communicates using an I2C bus. The I2C (Inter-Integrated Circuit) is a 2-wire serial communication protocol primarily used to connect microcontrollers with various peripheral devices such as sensors, displays, and so on. In the I2C bus, serial clock line (SCL) and serial data line (SDA) are utilized, data transmission and synchronization are performed among devices by using these two lines. In fact, the I2C device and the I2C bus may be understood by a person skilled in the art.

In traditional control, the upper-layer controller is connected to the optical module through an I2C expansion chip, and then realizes the protocol conversion from peripheral component interconnect express (PCIe) to I2C and the serial access of the optical module by accessing a field programmable gate array (FPGA) register based on the PCIe. In this access manner, since the design of the switch system limits the optical modules under the same I2C expansion chip to only be accessed serially, that is, the optical modules under the same I2C expansion chip are accessed serially, the access speed of the whole switch system is reduced.

### SUMMARY

An object of embodiments of the present application is to provide an information transmission apparatus, system, and method, so as to solve the technical problem in the related art that an access speed of a whole switch system is reduced because optical modules under the same I2C expansion chip in the switch system are accessed serially. The technical solutions are as follows.

In a first aspect of the implementation of the present application, an information transmission apparatus is first provided, the information transmission apparatus is communicatively connected to an upper-layer controller, and the information transmission apparatus includes: a plurality of inter-integrated circuit (I2C) controllers, each of the I2C controllers is configured to connect to an I2C interface of an I2C device.

In some embodiments, the information transmission apparatus further includes: a plurality of small form-factor pluggable (SFP) encapsulation modules, each of the SFP encapsulation modules is configured to connect to an I2C controller, and the upper-layer controller accesses the I2C device through the SFP encapsulation module.

In some embodiments, the each of the SFP encapsulation modules includes: a real-time access module, a polling access module, an instruction module, a first storage medium module, a second storage medium module, and a bus adaptation module, wherein
the real-time access module is communicatively connected to the first storage medium module, the instruction module, and the bus adaptation module; and
the polling access module is communicatively connected to the second storage medium module, the instruction module, and the bus adaptation module.

In some embodiments, the real-time access module is configured to control the I2C device in real time based on a real-time access mode according to a control command of the upper-layer controller; the real-time access mode includes implementing real-time access by the upper-layer controller to the I2C device through the information transmission apparatus, and the real-time access mode is used for debugging.

In some embodiments, the polling access module is configured to access the I2C device based on a polling access mode according to a control command of the upper-layer controller; the polling access mode includes performing periodic access by the information transmission apparatus to the I2C device after the upper-layer controller configures operation information of the I2C device completely; and the periodic access supports multi-page reading/writing of the I2C device.

In some embodiments, the instruction module is configured to invoke the I2C controllers.

In some embodiments, the upper-layer controller is communicated with the information transmission apparatus through a storage medium module; wherein the storage medium module is configured to store control information and state information of the upper-layer controller, or store I2C device data and store writing data of the upper-layer controller for the I2C device.

In some embodiments, the storage medium module includes: a register and a random access memory (RAM); and
that the upper-layer controller is communicated with the information transmission apparatus through the storage medium module includes: transferring, by the register, an instruction of the I2C device and a state of the I2C device read and written by the upper-layer controller, and transferring, by the RAM, the I2C device data read and written by the upper-layer controller, wherein address space mapped by the register and address space mapped by the RAM are different.

In some embodiments, the first storage medium module includes: a real-time access register and a first RAM, wherein
the real-time access register and the first RAM are communicatively connected to a real-time access module.

In some embodiments, the second storage medium module includes: a polling access register and a second RAM, wherein
the polling access register and the second RAM are communicatively connected to a polling access module.

In some embodiments, the first RAM includes a first port and a second port; and the second RAM includes a third port and a fourth port, wherein
in response to the first port being configured to reading data, the second port stops writing data; and in response to the third port being configured to reading data, the fourth port stops writing data.

In some embodiments, in response to the upper-layer controller reading data stored in the first RAM, write enable of the second port of the first RAM is forcibly disabled through the real-time access register; and
in response to the upper-layer controller reading data stored in the second RAM, write enable of the fourth port of the second RAM is forcibly disabled through the real-time access register.

In some embodiments, the information transmission apparatus further includes: a first peripheral component interconnect express (PCIe) interface module, wherein
the first PCIe interface module is configured to connect a plurality of SFP encapsulation modules and is communicatively connected to a second PCIe interface in the upper-layer controller based on PCIe.

In some embodiments, the information transmission apparatus further includes: a polling time register, wherein
the polling time register is configured to set polling time.

In some embodiments, the information transmission apparatus further includes: an I2C device address register, wherein
the I2C device address register is configured to configure an I2C address for accessing the I2C device.

In some embodiments, the information transmission apparatus further includes: an I2C controller rate register, wherein
the I2C controller rate register is configured to configure a communication rate of each of the I2C controllers.

In some embodiments, the information transmission apparatus is configured to drive the I2C controller and further configured to control driving of starting, reading/writing, register selection, and stopping of each of the I2C controllers.

In some embodiments, the information transmission apparatus and the upper-layer controller transmit commands and data in an in-band interrupt manner.

In a second aspect of the implementation of the present application, an information transmission system is further provided, which includes: the information transmission apparatus according to any one of the first aspect, the upper-layer controller, and the I2C devices, wherein
the information transmission apparatus is communicatively connected to the upper-layer controller and the I2C devices; and
the information transmission apparatus performs parallel access to the I2C devices through an I2C device control command sent by the upper-layer controller.

In a third aspect of the implementation of the present application, an information transmission method is further provided, which is applied to the information transmission apparatus according to any one of the first aspect, and includes:
performing parallel access to the I2C devices in response to an I2C device control command sent by an upper-layer controller being received; and
monitoring, during parallel access to the I2C devices, states of the I2C devices in real time, and returning the states of the I2C devices to the upper-layer controller.

An information transmission apparatus is provided by the embodiments of the present application, the information transmission apparatus includes: a plurality of I2C controllers, each of the I2C controllers is configured to connect to an I2C interface of an I2C device. That is, in the embodiments of the present application, the information transmission apparatus and the upper-layer controller are connected, and each I2C controller in the information transmission apparatus is connected to the I2C interface of an I2C device. The information transmission apparatus is configured to receive the control instruction sent by the upper-layer controller and perform parallel access to the I2C devices according to the control instruction. Thus, I2C controllers with the same number as I2C devices are disposed in the information transmission apparatus, thereby parallel access to the I2C devices by the information transmission apparatus is realized. Further, the information transmission apparatus is communicatively connected to the upper-layer controller, so that the upper-layer controller may realize parallel access to the I2C devices through the information transmission apparatus. The upper-layer controller does not need to repeatedly access the information transmission apparatus to drive to access the I2C devices, and further does not need to repeatedly drive the I2C controller, thereby the communication efficiency while reducing the occupancy rate of the upper-layer controller is improved. Further, since the optical module is equivalent to one I2C device, the upper-layer controller may realize parallel access to optical modules through the information transmission apparatus, which solves the problem in the related art that the access speed of the whole switch system is reduced because optical modules under the same I2C expansion chip in the switch system may only be accessed serially. In the embodiments of the present application, by disposing a plurality of I2C controllers, each of the I2C controllers is connected to the I2C interface of an I2C device, thereby efficient parallel access to the I2C devices is realized and the access efficiency of the I2C devices in a switch application is improved.

### BRIEF DESCRIPTION OF THE DRAWINGS

In order to more clearly illustrate the technical solutions in the embodiments of the present application or in the related art, the drawings required to be used in the descriptions of the embodiments or the related art will be briefly introduced below.

FIG. 1 is a schematic diagram of an information transmission apparatus according to an embodiment of the present application;

FIG. 2 is a schematic diagram of a real-time access module according to an embodiment of the present application;

FIG. 3 is a schematic diagram of a polling access module according to an embodiment of the present application;

FIG. 4 is a schematic structural diagram of a random access memory (RAM) according to an embodiment of the present application;

FIG. 5 is a schematic diagram of an information transmission system according to an embodiment of the present application; and

FIG. 6 is a flowchart of an information transmission method according to an embodiment of the present application.

### DETAILED DESCRIPTION

The technical solutions in the embodiments of the present application will be described below with reference to the drawings in the embodiments of the present application.

The embodiments set forth in the present application are merely used for explaining the present application and are not intended to limit the scope of the present application. The present application is described in the following paragraphs by examples with reference to the drawings. It should be noted that the drawings are all presented in a highly simplified form and use non-precise proportions, solely for the purpose of conveniently and clearly assisting in illustrating the embodiments of the present application.

It should be noted that an optical module is an important part of a switch system, by using the optical module, an external interface for the switch system is provided, so as to realize data communication among the local machine and different devices. The optical module provides management and state registers, and an upper-layer controller may acquire the state and control of the optical module from the registers of the optical module. Therefore, each optical module is equivalent to an I2C device. In traditional control, the upper-layer controller is connected to the optical module through an I2C expansion chip, and then realizes the protocol conversion from PCIe to I2C and the serial access of the optical module by accessing an FPGA register based on the PCIe. In this access manner, in an aspect, since the upper-layer controller needs to repeatedly access the FPGA register to drive an I2C controller, the design of the system limits the optical modules under the same I2C expansion chip to only be accessed serially, that is, at least the optical modules under the same PCA9538 are accessed serially, thus the access speed of the whole switch system is reduced.

In order to solve the above-mentioned problems, in a first aspect, an information transmission apparatus 1 is provided by some embodiments of the present application, which includes: a plurality of I2C controllers 10, each of the I2C controllers 10 is configured to connect to an I2C interface of an I2C device. That is, in the embodiments of the present application, referring to FIG. 5, the information transmission apparatus 1 and the upper-layer controller 2 are connected, and each I2C controller 10 in the information transmission apparatus 1 is connected to the I2C interface of an I2C device. Thus, in the information transmission apparatus 1, I2C controllers 10 with the same number as I2C devices 20 are instantiated, thereby parallel access to the I2C devices 20 by using the information transmission apparatus 1 is realized. Further, the information transmission apparatus 1 is communicatively connected to the upper-layer controller 2 so that the upper-layer controller 2 may realize parallel access to the I2C devices 20 through the information transmission apparatus 1. Since the optical module is equivalent to an I2C device, the upper-layer controller 2 may realize parallel access to optical modules through the information transmission apparatus 1 to solve the problem in the related art that the access speed of the whole switch system is reduced because optical modules under the same I2C expansion chip in the switch system may only be accessed serially. In the embodiments of the present application, by disposing a plurality of I2C controllers 10, each of the I2C controllers 10 is connected to the I2C interface of an I2C device, thereby efficient parallel access to the I2C devices 20 is realized and the access efficiency of the I2C devices 20 in a switch application is improved. The above-mentioned information transmission apparatus 1 will be described in detail below.

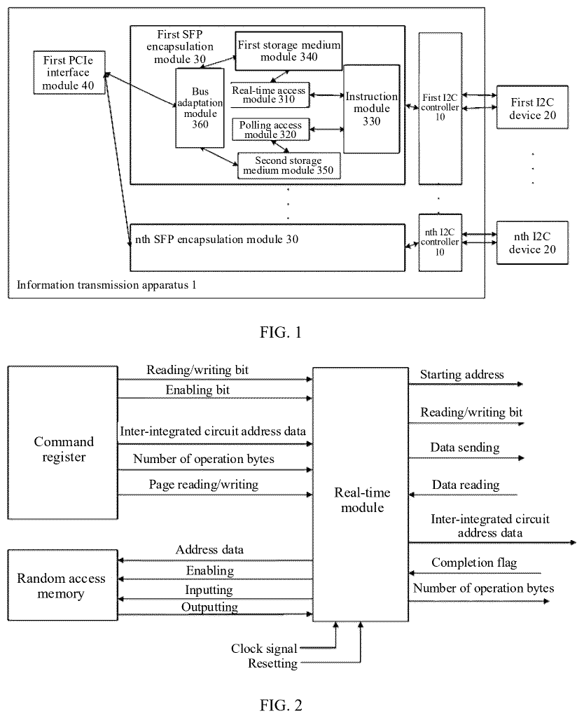

Referring to FIG. 1, FIG. 1 is a schematic diagram of an information transmission apparatus 1 according to an embodiment of the present application. It may be seen that the information transmission apparatus 1 includes a plurality of I2C controllers 10. Each I2C controller 10 is configured to connect to an I2C device.

It should be noted that the I2C device 20 may be an optical module. The optical module is an important part of a switch system, by using the optical module, an external interface for the switch system is provided, so as to realize data communication among the local machine and different devices. Therefore, an upper-layer controller 2 is especially important for controlling and accessing the optical module. In order to facilitate understanding by a person skilled in the art, in the embodiments of the present application, the I2C device 20 is described by taking the optical module as an example.

In some embodiments of the present application, the information transmission apparatus 1 realizes parallel access to I2C devices 20 by disposing I2C controllers 10 with the same number as I2C devices 20. The I2C controller 10 follows the signal behavior specification of the I2C controller 10 in various situations. Byte (8-bit) waveform control and single-bit serial clock line (SCL)/serial data line (SDA) control are mainly included. The byte waveform control follows change rules of starting, reading, writing, and stopping operation state machine in the I2C communication protocol, and the single-bit SCL/SDA control mainly controls changes of high and low levels of SCL/SDA according to the starting, reading, writing, and stopping operation state machine. SCL and SDA are signal lines of the I2C, SDA is a bidirectional data line, and SCL is a clock line. In the I2C, data transmission through SCL begins with the most significant bit. The host sends a starting signal, and SDA transitions from a high level to a low level during the high level of SCL. Then, the host sends one byte of data. After the data transmission is completed, the host sends a stopping signal, and SDA transitions from the low level to the high level during the high level of SCL.

In some embodiments of the present application, the information transmission apparatus 1 may be a semi-customized application-specific integrated circuit, i.e., an FPGA. The FPGA and hardware are completely parallel structures. The FPGA has a series of advantages such as flexible programming, fast response, and high integration and is more and more widely used in the early development and verification of many fields as well as control application fields. In the switch system, the data level management of the whole switch system is mainly realized by the FPGA, including I2C devices 20, management data clock and management data input/output (MDC/MDIO) devices, serial peripheral interface (SPI) devices, etc. Therefore, in order to facilitate understanding by a person skilled in the art, in some embodiments of the present application, the information transmission apparatus 1 is described by taking the FPGA as an example.

I2C controllers 10 with the same number as optical modules may be designed in the FPGA, and each I2C controller 10 is connected to an I2C interface of each optical module. In this way, the access rate of the switch system may be improved through a completely parallel architecture, and the completely parallel architecture realizes the physical isolation of the I2C, thereby the fault isolation of different optical modules is realized.

It should be noted that in some embodiments of the present application, the upper-layer controller 2 is generally a central processing unit (CPU). Therefore, in order to facilitate understanding by a person skilled in the art, in some embodiments of the present application, the upper-layer controller 2 is described by taking the CPU as an example.

In summary, in some embodiments of the present application, through the design of the FPGA module, the CPU only needs to access the FPGA during the application process, and the FPGA realizes parallel access to optical module devices according to a CPU control command. Furthermore, the optical module devices and the CPU are isolated, and the FPGA realizes parallel access to the optical modules. Thus, the CPU only needs to realize the parallel access of the FPGA. According to the present application, on the one hand, the design and access manners of the CPU are simplified, that is, only PCIe access is required; on the other hand, FPGA realizes access to the optical module device, thereby the usage occupancy rate of the CPU is reduced. The FPGA may monitor the state of the optical module in real time, thus the effective utilization rate of the I2C is improved. In actual tests, the effective communication rate of the protocol may reach 95%, while the effective communication rate of the protocol using the traditional upper-layer driver mode is only around 20%.

In some embodiments, the information transmission apparatus 1 further includes: a plurality of small form-factor pluggable (SFP) encapsulation modules 30. Each of the SFP encapsulation modules 30 is configured to connect to an I2C controller, and the upper-layer controller 2 accesses the I2C device 20 through the SFP encapsulation module.

It should be noted that in some embodiments of the present application, the information transmission apparatus 1 further includes the SFP encapsulation modules 30. Each SFP encapsulation module 30 is correspondingly connected to an I2C controller, each I2C controller 10 is connected to an I2C device 20, and the CPU may realize further access control to the I2C through the SFP encapsulation module.

Further, referring to FIG. 1, the SFP encapsulation module 30 includes: a real-time access module 310, a polling access module 320, an instruction module 330, a first storage medium module 340, a second storage medium module 350, and a bus adaptation module 360. The first storage medium module 340, the instruction module 330, and the bus adaptation module 360 are communicatively connected to the real-time access module 310. The second storage medium module 350, the instruction module 330, and the bus adaptation module 360 are communicatively connected to the polling access module 320.

In some embodiments of the present application, a modular design method is adopted for each module. For the FPGA, the code may be directly copied. For the CPU, since the optical module adopts regular register and RAM address division, code trimming is also facilitated.

In some embodiments, the real-time access module 310 is configured to control the I2C device 20 in real time based on a real-time access mode according to a control command of the upper-layer controller 2. The real-time access mode includes implementing real-time access by the upper-layer controller 2 to the I2C device 20 through the information transmission apparatus 1, and the real-time access mode is used for debugging.

In some embodiments, the polling access module 320 is configured to access the I2C device 20 based on a polling access mode according to the control command of the upper-layer controller 2. The polling access mode includes performing periodic access by the information transmission apparatus 1 to the I2C device 20 after the upper-layer controller 2 configures operation information of the I2C device 20 completely. The periodic access supports multi-page reading/writing of the I2C device.

It should be noted that the above-mentioned two access modules correspond to two access modes, i.e., the real-time access mode and the polling access mode, and each access mode corresponds to a different register in the FPGA module. The polling access mode only supports a reading operation, that is, the CPU may independently enable a particular optical module, and the FPGA may also periodically perform a reading operation on the particular optical module according to the configuration information of the CPU, store data in the RAM, and notify the CPU by using an interrupting way. The real-time access mode refers to that the CPU may perform real-time reading/writing operations on the particular optical module through the FPGA, and reading data and writing data are transferred through the RAM.

It should be noted that in some embodiments of the present application, firstly, the FPGA supports the CPU to control the optical module in real time through the real-time access module 310. As shown in FIG. 2, FIG. 2 is a schematic diagram of a real-time access module 310 provided in an embodiment of the present application. It may be seen that in FIG. 2, upper layers of a command (CMD) module and a data storage (RAM) module are bonded (coupled) to the CPU, and a downstream interface of the real-time access (RTC) module 310 is bonded to the instruction module 330. The control of the optical module by the CPU and the acquisition of the state of the optical module are performed through the CMD REG (command module). The real-time access (RTC) module 310 drives the instruction module 330 after acquiring instructions from the CMD REG, including the enable bit, reading/writing bit, data sending, data reading, starting address, and a quantity of operation bytes of the instruction module 330. Meanwhile, the instruction module 330 may feed back various completion flags. In FIG. 2, rw is the reading/writing bit, en is the enabling bit, starting represents the starting address, Iic_address_offset represents I2C address data, Bytes_num represents the quantity of operation bytes, Page_number represents page reading/writing, sys_clk represents a clock signal, reset_out represents a reset signal, txd represents data sending, rxd represents data reading, done_flag represents a completion flag, ram_addr represents address data, ram_en represents enabling, ram_in represents inputting, and ram_out represents outputting.

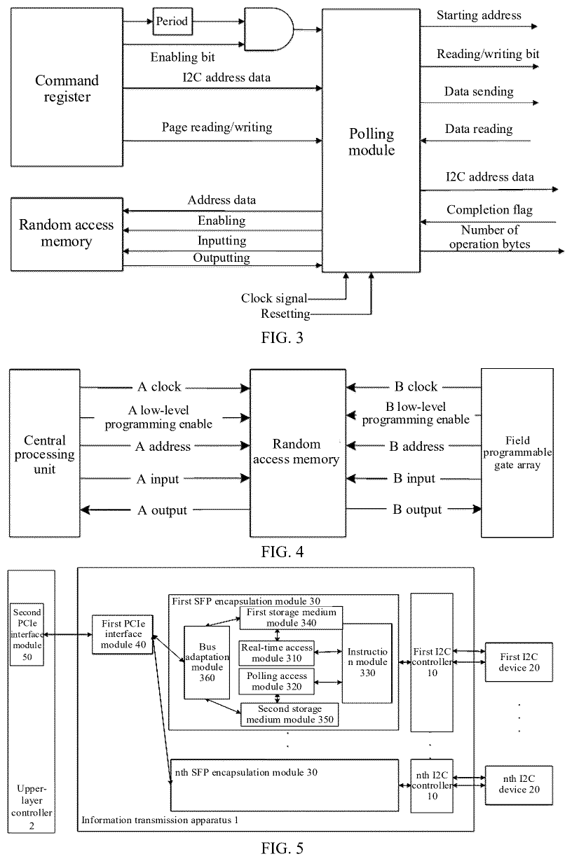

Secondly, the FPGA supports the CPU to poll information of the optical module through the polling access module 320. As shown in FIG. 3, FIG. 3 is a schematic diagram of a polling access module 320 provided in some embodiments of the present application. Compared with FIG. 2, periodic polling is added in FIG. 3, and Timer represents the periodic polling. The polling function module of the optical module in the polling access mode has a similar workflow to the real-time access function module, but the difference is that the polling operation only supports a reading operation. Meanwhile, the polling operation refers to periodically polling the information of the optical module, unlike the real-time operation, which only accesses the information of the optical module once.

In some embodiments, the instruction module 330 is configured to invoke the I2C controller.

It should be noted that the FPGA invokes the I2C controller 10 and the optical module through the instruction module 330 to realize communication. The data sent by the instruction module 330 is acquired from the RAM module, and the reading data will also be stored in a corresponding position of the RAM.

Further, the address, polling time, and I2C communication rate of the I2C device 20 may be flexibly configured through the register.

In some embodiments, the upper-layer controller 2 is communicated with the information transmission apparatus 1 through a storage medium module. The storage medium module is configured to store control information and state information of the upper-layer controller 2, or store I2C device 20 data and store writing data of the upper-layer controller 2 for the I2C device.

Further, the storage medium module includes a register and a RAM. That the upper-layer controller 2 is communicated with the information transmission apparatus 1 through the storage medium module includes: transferring, by the register, an instruction of the I2C device 20 and a state of the I2C device 20 read and written by the upper-layer controller 2, and transferring, by the RAM, the I2C device 20 data read and written by the upper-layer controller 2, wherein address space mapped by the register and address space mapped by the RAM are different.

It should be noted that in the FPGA, the register REG and the data RAM design adopt a modular design method, that is, each module adopts a continuous address. For example, SFP1 adopts a 0X1000-0X1FFC address, and SFP2 adopts a 0X2000-0X2FFC address. This address allocation manner facilitates the flexible expansion of the CPU and FPGA according to actual requirements, that is, the quantity of SFP encapsulation modules 30 in some embodiments of the present application may be designed according to actual requirements.

The register is first a control and state register corresponding to the real-time access mode of the optical module. When a page turning operation is performed on the optical module, the CPU needs to perform a writing operation on a 0X7F register of the optical module. Secondly, compared with the control and state register corresponding to the real-time access mode, a control and state register corresponding to the polling access mode has a basically similar specific function. The difference is that since the FPGA supports a multi-page operation in the polling mode, the CPU needs to specify an operation page of the optical module through the register, and the FPGA completes the page turning independently. The optical module is limited to operating only 128 bytes every time and cannot cross pages. Therefore, the CPU needs to specify through the register whether the operation to the optical module is the first 128 bytes or the last 128 bytes. The optical module only supports the reading operation in the polling operation mode, so there is no reading/writing operation control.

In some embodiments of the present application, the storage medium module composed of the register and the RAM may be configured for communication between the CPU and the FPGA. The instruction of the optical module and the state of the optical module read and written by the CPU may be transferred through the register, and the data FPGA of the optical module read and written by the CPU may be transferred through the RAM at the rate of PCIe Gen2. They are mapped to different addresses. The CPU and the FPGA adopt an in-band interrupt manner to transmit the command and data of communication, that is, the FPGA may generate an interrupt to the CPU after executing the command or data. Compared with the polling communication mechanism, the interrupt communication manner may further reduce the usage occupancy rate of the CPU and improve the communication efficiency.

Further, the first storage medium module 340 includes: a real-time access register and a first RAM. The real-time access register and the first RAM are communicatively connected to the real-time access module 310. The first RAM includes a first port and a second port. A second RAM includes a third port and a fourth port. When the upper-layer controller 2 reads data stored in the first RAM, write enable of the second port of the first RAM is forcibly disabled through the real-time access register.

The second storage medium module 350 includes: a polling access register and a second RAM. The polling access register and the second RAM are communicatively connected to the polling access module 320. When the first port is configured to reading data, the second port stops writing data. When the third port is configured to reading data, the fourth port stops writing data. When the upper-layer controller 2 reads data stored in the second RAM, write enable of the fourth port of the second RAM is forcibly disabled through the real-time access register.

It should be noted that since different access modes correspond to different registers and data storage RAMs, the SFP encapsulation module 30 includes the first storage medium module 340 and the second storage medium module 350. The first storage medium module 340 includes the first RAM and the real-time access register, and the second storage medium module 350 includes the second RAM and the polling access register.

The RAM is one of internal memories of the computer, and since the CPU and the FPGA perform data transfer through the RAM, in the embodiments of the present application, the RAM has a dual-port architecture. The first RAM includes the first port and the second port, and the second RAM includes the third port and the fourth port. The interface design of the RAM is shown in FIG. 4. FIG. 4 is a schematic structural diagram of a RAM provided in an embodiment of the present application. The RAM belongs to a dual-port RAM. An A side is bonded to a CPU end, and a B side is bonded to an FPGA logic end. That is, the A port may correspond to the first port, and the B port may correspond to the second port. “WE_B” also needs to be bonded to “Data RAM reading done”, that is, the CPU may control the FPGA to write to the RAM. For the control of RAM reading/writing, each RAM adds a “Data RAM reading done” write control bit. In order to prevent RAM read-writing data conflicts, when the CPU performs a reading operation, the FPGA logic prohibits a writing operation on the RAM.

In addition, the CPU may perform RAM reading/writing through one port, and the FPGA may perform RAM reading/writing through another port. Thus, it is necessary to handle the reading-writing conflict. That is, when the CPU reads data from the RAM through the first port, the FPGA needs to control logic not to write data to the RAM through another port. In addition, in the embodiments of the present application, when the CPU reads RAM data through the register, the write enable of the B port of the RAM module may be forcibly disabled through the register.

In some embodiments, the information transmission apparatus 1 further includes: a first PCIe interface module 40. The first PCIe interface module 40 is configured to connect a plurality of SFP encapsulation modules 30 and is communicatively connected to a second PCIe interface 50 in the upper-layer controller 2 based on PCIe (referring to FIG. 5).

It should be noted that the first PCIe interface module 40 includes a PCIe Endpoint. The FPGA implements the PCIe Endpoint, thereby PCIe communication between the CPU and the FPGA is realized. This function relies on the IO support of the FPGA itself to realize high-speed IO. There are many application scenarios to realize PCIe communication between the CPU and the FPGA. Its purpose is to realize high-speed PCIe communication between the CPU and the FPGA.

In addition, different hardcore configuration interfaces are provided for development tools from different manufacturers, but the basic configuration items are the same.

In some embodiments, the information transmission apparatus 1 further includes: a polling time register, an I2C device 20 address register, and an I2C controller 10 rate register. The polling time register is configured to set polling time. The I2C device 20 address register is configured to configure an I2C address for accessing the I2C device. The I2C controller 10 rate register is configured to configure a communication rate of each of the I2C controllers 10.

It should be noted that in some embodiments of the present application, the FPGA defines the polling time. The polling time may be set through the polling time register to meet the requirements under different working conditions. In the embodiments of the present application, the polling time may be set to 500 ms, which is not limited in the present application. Different polling times may be set according to the requirements of the switch or other systems.

It should be noted that in some embodiments of the present application, the FPGA defines the I2C device 20 address. The I2C address for accessing the I2C device 20 may be configured through the I2C device 20 address register. Further, the FPGA may also define the optical module. The register may satisfy access to addresses of different optical modules such as DSFP and QSFP through the optical modules, and it may be satisfied that the FPGA accesses any I2C device 20 according to the I2C device 20 address register. Therefore, in the embodiments of the present application, an optical module device address may be set to 7′h50, and the CPU may configure the address of the I2C device 20 through the FPGA.

It should be noted that in some embodiments of the present application, the FPGA defines the I2C controller 10 rate register. The communication rate of the I2C controller 10 may be configured through the I2C controller 10 rate register. For example, the communication rate may reach 100 kbit/s in a standard mode, 400 kbit/s in a fast mode, and 3.4 Mbit/s in a high-speed mode. In the embodiments of the present application, the communication rate may be set to 100 kbit/s, which is not limited in the present application. Different communication rates may be set according to the requirements of the switch or other systems.

In some embodiments, the information transmission apparatus 1 is configured to drive the I2C controller 10 and further configured to control the driving of starting, reading/writing, register selection, and stopping of each of the I2C controllers 10.

It should be noted that in some embodiments of the present application, the FPGA may drive the I2C controller. The driving of the whole I2C controller 10 device waveform such as starting, reading/writing, register selection, and stopping of the I2C controller 10 is controlled. Compared with the traditional upper-layer driving manner, the protocol effective communication rate of this driving manner may reach 95% because the FPGA directly faces the optical module device signal, while the protocol effective communication rate of the traditional upper-layer driving manner is only about 20%.

In addition, in some embodiments of the present application, the I2C driving manner of the I2C device 20 is transferred from the upper-layer controller 2 to the information transmission apparatus 1, thereby the resource occupancy rate of the upper-layer controller 2 is reduced.

In some embodiments, the information transmission apparatus 1 and the upper-layer controller 2 transmit commands and data in an in-band interrupt manner.

It should be noted that in some embodiments of the present application, in order to improve the communication rate between the upper-layer controller 2 and the information transmission apparatus 1, when the information transmission apparatus 1 and the upper-layer controller 2 perform command and data transmission communication through a PCIe protocol, an interrupt manner is further adopted based on the PCIe communication, that is, after the operation on the optical module by the information transmission apparatus 1 is completed, an in-band interrupt is generated through the PCIe to notify the upper-layer controller 2 so that the upper-layer controller 2 may quickly know whether the operation on the optical module is completed.

An information transmission apparatus 1 is provided by some embodiments of the present application, which includes: a plurality of I2C controllers 10, each of the I2C controllers 10 is configured to connect to an I2C interface of an I2C device. That is, in the embodiments of the present application, the information transmission apparatus 1 and the upper-layer controller 2 are connected, and each I2C controller 10 in the information transmission apparatus 1 is connected to the I2C interface of an I2C device. The information transmission apparatus 1 is configured to receive the control instruction sent by the upper-layer controller 2 and perform parallel access to the I2C devices 20 according to the control instruction. Thus, I2C controllers 10 with the same number as I2C devices 20 are disposed, thereby parallel access to the I2C devices 20 by the information transmission apparatus 1 is realized. Further, the information transmission apparatus 1 is communicatively connected to the upper-layer controller 2 so that the upper-layer controller 2 may realize parallel access to the I2C devices 20 through the information transmission apparatus 1. The upper-layer controller 2 does not need to repeatedly access the information transmission apparatus 1 to drive to access the I2C devices 20, and further does not need to repeatedly drive the I2C controller, thereby the communication efficiency while reducing the occupancy rate of the upper-layer controller 2 is improved. Further, since the optical module is equivalent to an I2C device 20, the upper-layer controller 2 may realize parallel access to optical modules through the information transmission apparatus 1 to solve the problem in the related art that the access speed of the whole switch system is reduced because optical modules under the same I2C expansion chip in the switch system may only be accessed serially. In the embodiments of the present application, by disposing a plurality of I2C controllers 10, each of the I2C controllers 10 is connected to the I2C interface of an I2C device 20, thereby efficient parallel access to the I2C devices 20 is realized and the access efficiency of the I2C devices 20 in a switch application is improved.

In addition, in some embodiments of the present application, the access efficiency of the optical module device in the switch application is improved through the parallel access mechanism for the optical module, and the CPU resource occupancy rate is effectively reduced. The I2C driving manner for the optical module is transferred from the CPU to the FPGA, thereby the resource occupancy rate of the CPU is reduced. The FPGA and the CPU support real-time access and polling access to the optical modules, making the access more flexible on the basis of improving efficiency. The natural parallel access characteristics of the FPGA and the parallel independent access mechanism of many optical modules realize the independence of the optical modules on the basis of improving the access efficiency, thereby the fault isolation of the optical module devices is realized. The present application supports configuration of the device address, and therefore may be applied to any I2C device 20 field.

According to a second aspect, an information transmission system is provided by some embodiments of the present application. The information transmission system includes the information transmission apparatus 1 according to any one of the first aspect, the upper-layer controller 2, and the I2C devices 20. The above-mentioned information transmission system will be described in detail below.

It should be noted that in some embodiments of the present application, as shown in FIG. 5, FIG. 5 is a schematic diagram of an information transmission system according to some embodiments of the present application. The information transmission system includes the information transmission apparatus 1, the upper-layer controller 2, and the I2C devices 20. The information transmission apparatus 1 is communicatively connected to the upper-layer controller 2 and the I2C devices 20. The information transmission apparatus 1 performs parallel access to the I2C devices 20 through an I2C device 20 control command sent by the upper-layer controller 2.

Therefore, in some embodiments of the present application, the upper-layer controller 2 needs to access the I2C devices 20, but actually, the upper-layer controller 2 only needs to access the information transmission apparatus 1. The information transmission apparatus 1 realizes parallel access to the I2C devices 20 according to the control command of the upper-layer controller 2 and the internal structure of the information transmission apparatus 1. Furthermore, the I2C devices 20 and the upper-layer controller 2 are isolated, and the information transmission apparatus 1 realizes parallel access to the optical modules. Therefore, the upper-layer controller 2 only needs to realize the parallel access of the information transmission apparatus 1.

On the one hand, the above-mentioned information transmission system simplifies the design and access manners of the upper-layer controller 2, that is, only PCIe access is required. On the other hand, the information transmission apparatus 1 realizes access to the I2C device 20, thereby the usage occupancy rate of the upper-layer controller 2 is reduced. The upper-layer controller 2 does not need to directly access the I2C device 20, and the information transmission apparatus 1 may monitor the state of the I2C device 20 in real time and feed back the state of the I2C device 20 to the upper-layer controller 2, thereby the effective utilization rate of the I2C device 20 is improved.

An information transmission system is provided by some embodiments of the present application, which includes the information transmission apparatus 1, the upper-layer controller 2, and the I2C devices 20. The information transmission apparatus 1 includes: the plurality of I2C controllers 10, each of the I2C controllers 10 is configured to connect to an I2C interface of an I2C device. That is, in the embodiments of the present application, the information transmission apparatus 1 and the upper-layer controller 2 are connected, and each I2C controller 10 in the information transmission apparatus 1 is connected to the I2C interface of an I2C device. Thus, in the information transmission apparatus 1, I2C controllers 10 with the same number as I2C devices 20 are instantiated, thereby parallel access to the I2C devices 20 by the information transmission apparatus 1 is realized. Further, the information transmission apparatus 1 is communicatively connected to the upper-layer controller 2 so that the upper-layer controller 2 may realize parallel access to the I2C devices 20 through the information transmission apparatus 1. Since the optical module is equivalent to an I2C device 20, the upper-layer controller 2 may realize parallel access to optical modules through the information transmission apparatus 1 to solve the problem in the related art that the access speed of the whole switch system is reduced because optical modules under the same I2C expansion chip in the switch system may only be accessed serially. In the embodiments of the present application, by disposing a plurality of I2C controllers 10, each of the I2C controllers 10 is connected to the I2C interface of an I2C device 20, thereby efficient parallel access to the I2C devices 20 is realized and the access efficiency of the I2C devices 20 in a switch application is improved.

In addition, in some embodiments of the present application, the access efficiency of the optical module device in the switch application is improved through the parallel access mechanism for the optical module, and the CPU resource occupancy rate is effectively reduced. The I2C driving manner for the optical module is transferred from the CPU to the FPGA, thereby the resource occupancy rate of the CPU is reduced. The FPGA and the CPU support real-time access and polling access to the optical modules, making the access more flexible on the basis of improving efficiency. The natural parallel access characteristics of the FPGA and the parallel independent access mechanism of many optical modules realize the independence of the optical modules on the basis of improving the access efficiency, thereby the fault isolation of the optical module devices is realized. The present application supports configuration of the device address, and therefore may be applied to any I2C device 20 field.

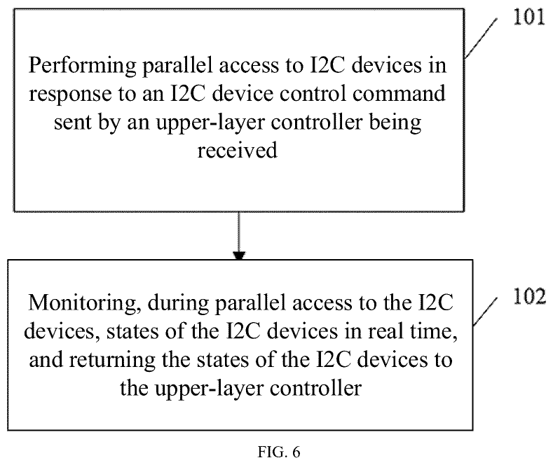

According to a third aspect, an information transmission method is provided by some embodiments of the present application. The method is applied to any information transmission apparatus in the first aspect. As shown in FIG. 6, the method includes the following steps.

Step 101, performing parallel access to I2C devices in response to an I2C device control command sent by an upper-layer controller being received.

It should be noted that in some embodiments of the present application, for the information transmission apparatus, for example, an FPGA, when the FPGA receives a control command or access request of the I2C device sent by the upper-layer controller, for example, the CPU, the FPGA directly accesses the I2C device (for example, an optical module).

Since the quantity of the I2C controller in the FPGA is equal to the quantity of optical modules, and each I2C controller is connected to an I2C interface of an optical module, the FPGA may realize parallel access to the optical modules.

Step 102, monitoring, during parallel access to the I2C devices, states of the I2C devices in real time, and returning the states of the I2C devices to the upper-layer controller.

It should be noted that in some embodiments of the present application, during the parallel access of the information transmission apparatus to the I2C devices according to the control command or access request of the CPU, the information transmission apparatus monitors the states of the I2C devices in real time and returns the states of the I2C devices to the upper-layer controller.

In some embodiments of the present application, the upper-layer controller and the information transmission apparatus 1 adopt an in-band interrupt manner to transmit the command and data of communication, that is, the FPGA may generate an interrupt to the CPU after executing the command or data. Compared with the polling communication mechanism, the interrupt communication manner may further reduce the usage occupancy rate of the upper-layer controller 2 and improve the communication efficiency.

In addition to the above-mentioned examples, the user may monitor, access, control, and read the I2C device through the information transmission method in the embodiment of the present application, which is not limited in the present application. The user may determine the information transmission method according to the actual situation.

According to the information transmission method provided in some embodiments of the present application, parallel access to the I2C devices is performed when the I2C device control command sent by the upper-layer controller is received. During parallel access to the I2C devices, the states of the I2C devices are monitored in real time and returned to the upper-layer controller. In the embodiments of the present application, the I2C driving manner of the I2C device is transferred from the upper-layer controller to the information transmission apparatus, thereby the resource occupancy rate of the upper-layer controller is reduced. In addition, the quantity of the I2C controllers in the information transmission apparatus is equal to the quantity of I2C devices, and each I2C controller is connected to the I2C interface of an I2C device so that the upper-layer controller realizes parallel access to the I2C devices through the information transmission apparatus.

Further, the information transmission apparatus in some embodiments of the present application includes: a plurality of I2C controllers, each of the I2C controllers is configured to connect to an I2C interface of an I2C device. That is, in the embodiments of the present application, the information transmission apparatus and the upper-layer controller are connected, and each I2C controller in the information transmission apparatus is connected to the I2C interface of an I2C device. Thus, in the information transmission apparatus, I2C controllers with the same number as I2C devices are instantiated, thereby parallel access to the I2C devices by the information transmission apparatus is realized. Further, the information transmission apparatus is communicatively connected to the upper-layer controller so that the upper-layer controller may realize parallel access to the I2C devices through the information transmission apparatus. Since the optical module is equivalent to an I2C device, the upper-layer controller may realize parallel access to optical modules through the information transmission apparatus to solve the problem in the related art that the access speed of the whole switch system is reduced because optical modules under the same I2C expansion chip in the switch system may only be accessed serially. In the embodiments of the present application, by disposing a plurality of I2C controllers, each of the I2C controllers is connected to the I2C interface of an I2C device, thereby efficient parallel access to the I2C devices is realized and the access efficiency of the I2C devices in a switch application is improved.

It should be noted that relational terms such as first and second herein are used only to distinguish one entity or operation from another entity or operation without necessarily requiring or implying any actual such relationships or orders between these entities or operations. Furthermore, the terms “include”, “contain”, or any other variation thereof are intended to cover a non-exclusive inclusion so that a process, method, article, or device that includes a list of elements does not include only those elements but may include other elements not expressly listed or inherent to such process, method, article, or device. An element limited by the phrase “including a ...” does not, without more constraints, preclude the existence of additional identical elements in the process, method, article, or device that includes the element.

It should be noted that when a component is referred to as “fixed” to another component, it may be directly on another component, or there may be a centering component. When one component is considered to be “connected” to another component, it may be directly connected to another component, or there may be a centering component at the same time. When one component is considered to be “disposed on” another component, it may be directly disposed on another component, or there may be a centering component at the same time. As used herein, the terms “vertical,” “horizontal,” “left,” “right,” and similar expressions are for illustrative purposes only.

The various embodiments described herein are described in a related manner. The identical and similar parts of the various embodiments may refer to each other, and each embodiment focuses on the differences from other embodiments. In particular, for the system embodiment, which is substantially similar to the method embodiment, the description is relatively simple. Related details may refer to the corresponding parts of the method embodiments.

The above are merely some embodiments of the present application and are not intended to limit the scope of the present application. Any modifications, equivalents, improvements, etc. made within the spirit and principles of the present application should be included within the scope of the present application.

The host device and the computer system provided in the present application are described in detail above. Examples are applied herein to illustrate the principles and implementations of the present application, and the above illustrations of the embodiments are only used to help understand the structure of the present application and its core ideas. Meanwhile, for a person skilled in the art, according to the ideas of the present application, there will be changes in the implementations and the scope of application. In summary, the contents of this specification should not be construed as limiting the present application.

1. An information transmission apparatus, the information transmission apparatus being communicatively connected to an upper-layer controller, and the information transmission apparatus comprising: a plurality of inter-integrated circuit (I2C) controllers, each of the I2C controllers being configured to connect to an I2C interface of an I2C device, wherein the information transmission apparatus is configured to receive a control instruction sent by the upper-layer controller and perform parallel access to I2C devices according to the control instruction, and the upper-layer controller comprises a central processing unit (CPU).

2. The information transmission apparatus according to claim 1, wherein the information transmission apparatus further comprises: a plurality of small form-factor pluggable (SFP) encapsulation modules, each of the SFP encapsulation modules is configured to connect to one of the I2C controllers, and the upper-layer controller accesses the I2C device through the SFP encapsulation module.

3. The information transmission apparatus according to claim 2, wherein the each of the SFP encapsulation modules comprises: a real-time access module, a polling access module, an instruction module, a first storage medium module, a second storage medium module, and a bus adaptation module, wherein
the real-time access module is communicatively connected to the first storage medium module, the instruction module, and the bus adaptation module; and
the polling access module is communicatively connected to the second storage medium module, the instruction module, and the bus adaptation module.

4. The information transmission apparatus according to claim 2, wherein the real-time access module is configured to control the I2C device in real time based on a real-time access mode according to a control command of the upper-layer controller; the real-time access mode comprises implementing real-time access by the upper-layer controller to the I2C device through the information transmission apparatus, and the real-time access mode is used for debugging.

5. The information transmission apparatus according to claim 2, wherein the polling access module is configured to access the I2C device based on a polling access mode according to a control command of the upper-layer controller; the polling access mode comprises performing periodic access by the information transmission apparatus to the I2C device after the upper-layer controller configures operation information of the I2C device completely; and the periodic access supports multi-page reading/writing of the I2C device.

6. The information transmission apparatus according to claim 2, wherein the instruction module is configured to invoke the I2C controllers.

7. The information transmission apparatus according to claim 2, wherein the upper-layer controller is communicated with the information transmission apparatus through a storage medium module; wherein the storage medium module is configured to store control information and state information of the upper-layer controller, or store I2C device data and store writing data of the upper-layer controller for the I2C device.

8. The information transmission apparatus according to claim 7, wherein the storage medium module comprises: a register and a random access memory (RAM); and
that the upper-layer controller is communicated with the information transmission apparatus through the storage medium module comprises: transferring, by the register, an instruction of the I2C device and a state of the I2C device read and written by the upper-layer controller, and transferring, by the RAM, the I2C device data read and written by the upper-layer controller, wherein address space mapped by the register and address space mapped by the RAM are different.

9. The information transmission apparatus according to claim 3,
wherein the first storage medium module comprises: a real-time access register and a first RAM, wherein
the real-time access register and the first RAM are communicatively connected to a real-time access module.

10. The information transmission apparatus according to claim 7, wherein the second storage medium module comprises: a polling access register and a second RAM, wherein
the polling access register and the second RAM are communicatively connected to a polling access module.

11. The information transmission apparatus according to claim 9, wherein the first RAM comprises a first port and a second port, wherein
in response to the first port being configured to reading data, the second port stops writing data.

12. (canceled)

13. The information transmission apparatus according to claim 1, wherein the information transmission apparatus further comprises: a first peripheral component interconnect express (PCIe) interface module, wherein
the first PCIe interface module is configured to connect a plurality of SFP encapsulation modules and is communicatively connected to a second PCIe interface in the upper-layer controller based on PCIe.

14. The information transmission apparatus according to claim 1, wherein the information transmission apparatus further comprises: a polling time register, wherein
the polling time register is configured to set polling time.

15. The information transmission apparatus according to claim 1, wherein the information transmission apparatus further comprises: an I2C device address register, wherein
the I2C device address register is configured to configure an I2C address for accessing the I2C device.

16. The information transmission apparatus according to claim 1, wherein the information transmission apparatus further comprises: an I2C controller rate register, wherein
the I2C controller rate register is configured to configure a communication rate of each of the I2C controllers.

17. The information transmission apparatus according to claim 1, wherein the information transmission apparatus is configured to drive the I2C controller and further configured to control driving of starting, reading/writing, register selection, and stopping of each of the I2C controllers.

18. The information transmission apparatus according to claim 1, wherein the information transmission apparatus and the upper-layer controller transmit commands and data in an in-band interrupt manner.

19. An information transmission system, comprising: the information transmission apparatus according to claim 1, the upper-layer controller, and the I2C devices, wherein
the information transmission apparatus is communicatively connected to the upper-layer controller and the I2C devices; and
the information transmission apparatus performs parallel access to the I2C devices through an I2C device control command sent by the upper-layer controller.

20. An information transmission method, applied to the information transmission apparatus according to claim 1, and comprising:
performing parallel access to the I2C devices in response to an I2C device control command sent by an upper-layer controller being received; and
monitoring, during parallel access to the I2C devices, states of the I2C devices in real time, and returning the states of the I2C devices to the upper-layer controller.

21. The information transmission apparatus according to claim 10, wherein the second RAM comprises a third port and a fourth port, wherein in response to the third port being configured to reading data, the fourth port stops writing data.
